(19) United States
(12) Patent Application Publication
(10) Pub. No.: US 2014/0069113 A1
(43) Pub. Date: Mar. 13, 2014

(54) BATTERY SYSTEM

(71) Applicants: HYUNDAI MOTOR COMPANY, Seoul (KR); KIA MOTORS CORPORATION, Seoul (KR)

(72) Inventors: Man Ju Oh, Yongin (KR); Jae Woong Kim, Hwaseong (KR); Jae Woo Park, Ansan (KR)

(73) Assignees: KIA MOTORS CORPORATION, Seoul (KR); HYUNDAI MOTOR COMPANY, Seoul (KR)

(21) Appl. No.: 13/691,593

(22) Filed: Nov. 30, 2012

(30) Foreign Application Priority Data
Sep. 7, 2012 (KR) 10-2012-0099404

(51) Int. Cl. H01M 2/00; F25B 21/04

(52) U.S. Cl. CPC H01M 2/00; F25B 21/04
USPC 62/3.3

(57) ABSTRACT

Disclosed herein is a battery system including: an airtight housing through which air is blocked; a battery pack unit disposed in the airtight housing; a suction opening and a discharging opening disposed in the airtight housing; an airtight cooling device spaced apart from the airtight housing and from a vehicle seat, wherein the cooling device is connected to the suction opening and the discharging opening through a suction duct and a discharging duct, a blowing fan disposed in the airtight housing, wherein the blowing fan is configured to circulate the air in the airtight housing; and a thermoelectric element disposed on an air circulating flow path of the airtight cooling device, wherein the thermoelectric element is configured to cool or heat the circulated air.

### CROSS-REFERENCE

This application claims under 35 U.S.C.§119(a) the benefit of Korean Patent Application No. 10-2012-0099404 filed Sep. 7, 2012 the entire contents of which are incorporated herein by reference.

### BACKGROUND OF THE INVENTION

(a) Field of the Invention

The present invention relates to a battery system, capable of improving efficiency of a battery used in a vehicle through cooling or heating of the battery.

(b) Description of the Related Art

Recently, efforts have been made in various industrial fields for replacing an internal combustion engine with an electrical engine to help solve environmental problems. Here, a battery serves as an alternative to fuel in the electrical engine and should maintain an optimal state of a fuel efficiency ratio or durability through increasing and decreasing a temperature of the battery used in the electrical vehicle and a hybrid vehicle.

Many conventional battery cooling and heating technologies are configured to suction air from an interior and an exterior of a vehicle and transfer the air to the battery for cooling the battery through air convection. In the prior configurations for simultaneously cooling and heating the battery, as described above, a plurality of battery packs and electrical devices may be disposed inside a battery housing. Thus, separate ducts may be disposed on a suction portion and a discharging portion for an air flow path for heat exchanging to be defined inside the battery pack and for air to flow therethrough.

Further, separate flow channels may be disposed on the exterior of the battery pack for the air flow path to be defined therein and thus, there are limitations to designing the battery system and efficiency of the cooling configuration for the battery may not be achieved.

For example, in case of Korean Patent Application No. 10-2012-006927A, entitled “A battery pack including radial fans,” relates to a battery pack including radial fans in which the radial fans are arranged such that the input and output direction of cooling air becomes perpendicular to the directions of the cooling air traversing through a plurality of battery cells to design a more efficient the flow path of the cooling air. However, under this configuration of the battery pack, separate channels and ducts for the cooling air flow must be provided, the cooling effect may decrease due to the substantially long cooling air flow. Further, even though the battery and the cooling device are arranged on one point or several points separately in this configuration, the fans of the air cooling device may be disposed on a rear seat causing noise.

The items described above are provided just to help in understanding of the background of the present invention, and shall not be construed to admit that they correspond to the technologies already known to those skilled in the art to which the present invention pertains.

### SUMMARY OF THE INVENTION

The present invention has been made in an effort to solve the above-described problems associated with prior art. An object of the present invention is to provide a battery system, capable of minimizing cooling air flow and decreasing the space required for heating and cooling the battery system components.

In one embodiment, the battery system includes: a substantially airtight housing through which air may be blocked; a plurality of battery packs disposed in the airtight housing; a suction opening and a discharging opening formed in the airtight housing; a substantially airtight cooling device spaced from the airtight housing and from a seat of a vehicle, wherein the cooling device may be connected to the suction opening and the discharging opening by a suction duct and a discharging duct, the cooling device may include a blowing fan for circulating air in the airtight housing; and a thermoelectric element disposed on an air circulating flow path of the airtight cooling device to cool or heat the circulated air.

The airtight housing may be disposed on a side of a vehicle floor and the cooling device may be disposed on a side of a vehicle trunk. The suction opening may be disposed on a lower portion of the airtight housing through which air may be suctioned and the discharging opening may be disposed on an upper portion of the airtight housing through which the air may be discharged. The blowing fan may be a radial type fan wherein the air may be suctioned toward a middle of the fan and may be discharged to a side of the airtight housing.

The cooling device may include a suction duct, a discharging duct and a blowing fan. Additionally, a thermoelectric element may be disposed on an air flow path of multiple cooling devices. The airtight housing, the suction duct, the discharging duct and the cooling device may be blocked from external air intact. forming a closed flow path. The thermoelectric element may be disposed within the suction duct or the discharging duct.

The cooling device unit may be formed as a plurality of cooling devices, each cooling device may include a suction duct and a blowing fan. The ducts may be divided from the discharging duct and may be connected to the blowing fans. Additionally, the thermoelectric element may be disposed on an air flow path of the respective plurality of cooling devices. Furthermore, the thermoelectric element may be disposed within the suction ducts.

The battery pack unit in the airtight housing may be formed as a plurality of battery packs disposed in columns wherein a connection duct may connect the columns of the battery packs. Additionally, the discharging opening may be connected to the discharging duct within the airtight housing, corresponding to the respective columns of the battery pack unit. One end of the connection duct may be connected to the discharging opening and the other end thereof may be divided to be connected the respective columns of the battery pack unit wherein air flows through the respective battery packs.

### BRIEF DESCRIPTION OF THE DRAWINGS

The above and other features, objects and advantages of the present invention will now be more clearly understood from the following detailed description taken in conjunction with the accompanying drawings which are given hereinbelow by way of illustration only, and thus are not limitative of the present invention, and wherein:

FIG. 1 is an exemplary view illustrating a battery system according to an exemplary embodiment of the present invention;

FIG. 2 is an exemplary side-sectional view illustrating a battery system according to an exemplary embodiment of the present invention; and

FIG. 3 is an exemplary plane-sectional view illustrating a battery system according to an exemplary embodiment of the present invention.

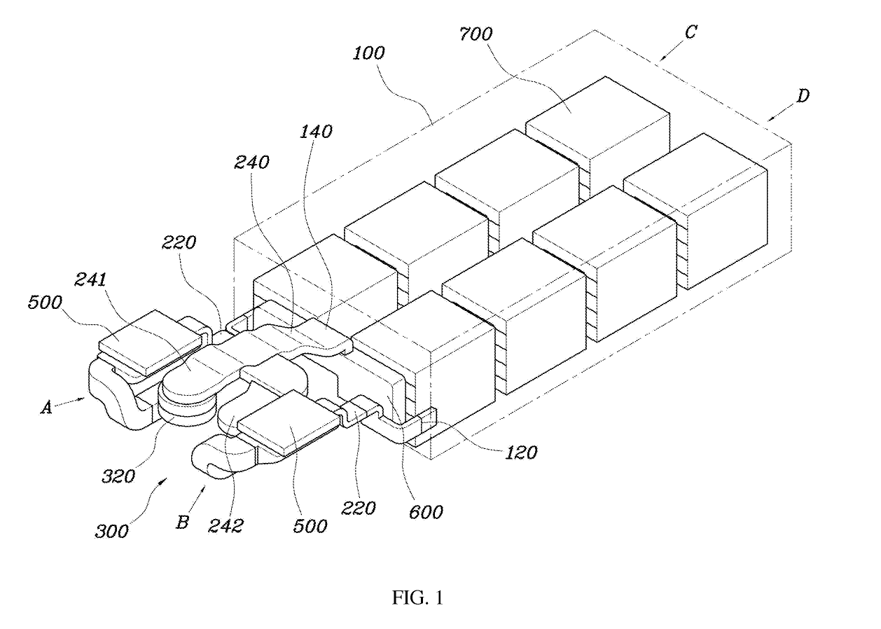

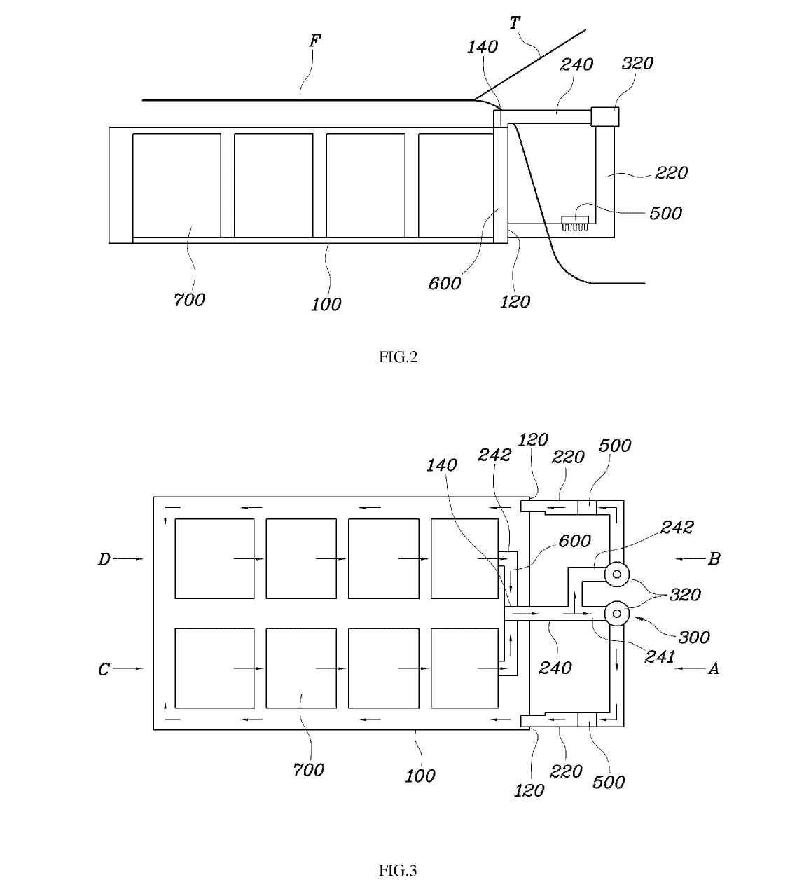

It should be understood that the accompanying drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DESCRIPTION OF PREFERRED EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a”, “an ” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, a battery system for a vehicle according to an exemplary embodiment of the present invention will be described with reference to the accompanying drawings.

A battery system according to an embodiment of the present invention includes: a substantially airtight housing 100 through which air may be blocked; a battery pack unit 700 disposed in the airtight housing; a suction opening 120 and a discharging opening 140 formed in the airtight housing; a substantially airtight cooling device 300 spaced from the airtight housing 100 and from a seat of a vehicle, wherein the cooling device may be connected to the suction opening 120 and the discharging opening 140 by a suction duct 220 and a discharging duct 240, with the cooling device may include a blowing fan for circulating air in the airtight housing 100; and a thermoelectric element 500 disposed on an air circulating flow path of the airtight cooling device 300 to cool or heat the circulated air.

In the battery system according to the present invention, the battery pack unit 700 is substantially spaced from the cooling device 300 to ensure the performance of the battery and to help solve noise disturbances. Further, the battery system may be designed to be substantially airtight to form a closed flow path, thereby increasing air cooling efficiency of the battery system.

In one embodiment of the battery system, the housing, through which air may be blocked, may be substantially airtight. A battery pack unit 700 may be disposed within the housing. Additionally, a suction opening 120 and a discharging opening 140 may be formed within the housing 100. The suction opening 120 and the discharging opening 140 may be disposed on a side of a vehicle floor F and the cooling device 300 may be disposed on a side of a trunk T. The battery occupies a relatively large space, and the battery may be stably disposed below a rear seat of the vehicle to lower a gravity center of the vehicle. Furthermore, the cooling device 300 may be spaced to a side of the trunk T due to decrease noise from the blowing fan 320. The housing 100 may be fixed to a trim or a panel on the side of the floor F and the cooling device 300 may be disposed on an interior part or a lower part of a compartment on the side of the trunk T. Additionally, the cooling device 300 may be disposed in the trunk T wherein waste heat from the cooling device may operate the thermoelectric element 500.

Moreover, the suction opening 120 may be disposed on a lower portion of the suction housing 100 through which the air may be suctioned and the discharging opening 140 may be disposed on an upper portion of the housing 100 through which the air may be discharged.

Further, the blowing fan 320 may be a radial type fan wherein air may be suctioned toward a middle of the blowing fan and discharged to a side of the airtight housing. Thus, the blowing fan 320 may be disposed on a substantially small space according to the positions of the vertically separated suction opening 120 and discharge opening 140.

One embodiment may include a cooling device unit A, B each cooling device including a suction duct 220, a discharging duct 240 and a blowing fan 320. Additionally, a thermoelectric element 500 may be disposed on an air flow path of the respective cooling devices units A, B, or the thermoelectric element 500 may be disposed within the suction duct 220 or the discharging duct 240.

More specifically, the cooling device unit A, B may include a suction duct 220 and a blowing fan 320, and divided ducts 241, 242 which may be divided from the discharging duct 240 and may be connected to the blowing fan 320, respectively. Additionally, the thermoelectric element 500 may be disposed on an air flow path of the respective cooling device unit A, B, and the thermoelectric element 500 may be disposed within the respective suction ducts 220.

In this configuration, the battery system according to the present invention may form a closed flow path in which the housing 100, the suction duct 220, the discharging duct 240 and the cooling device 300 may block suction of external air.

In another embodiment, the battery system may include a plurality of blowing fans, wherein when one blowing fan fails, another blowing fan be operated. Similarly, the battery system may include a plurality of thermoelectric elements, wherein one thermoelectric element may be operated to protect the battery when another thermoelectric element may have failed. Furthermore, when they plurality of blowing fans and the plurality of thermoelectric elements are controlled independently, cooling and heating the cooling device may be performed more efficiently.

Moreover, the battery system may include a battery pack unit disposed in the airtight housing 100 wherein the battery pack unit may form columns C, D. Furthermore, a connection duct 600 may be disposed in the airtight housing 100 to connect the columns C, D of the battery pack unit. Additionally, the discharging opening 140 may be connected to the discharging duct 240 within the airtight housing 100, corresponding to the respective columns C, D of the battery pack unit. In particular, one end of the connection duct 600 may be connected to the discharging opening 140 and the other end thereof may be divided to be connected the respective columns C, D of the battery pack unit wherein air flows through the respective battery packs.

In this configuration, the air blown from the blowing fan 320 may be cooled through the thermoelectric element 500 and the cool air may flow between the columns C, D of the battery pack unit or between the columns C, D of the battery pack unit and an inner wall of the airtight housing through the respective suction duct 220 and the suction opening 120, and the air blown may flow around a rear portion of the housing and may be input into a rear portion of the battery pack 700.

Specifically, air may flow through the interior portion of the battery pack unit and the cooled air may be heat-exchanged as it flows through the columns C, D of the battery pack unit. The heat-changed air may be collected in the discharging opening 140 through the connection duct 600 at a front portion of the airtight housing and then collected at the blowing fan 320 through the discharging duct 240. Accordingly, the cooled air may be efficiently supplied to the battery pack unit 700 within the airtight housing 100, thereby cooling the interior of the housing 100. Further, the heat-exchanged air may be collected at the blowing fan 320 without leaking out of the airtight housing and may be cooled at the thermoelectric element 500 to increase cooling efficiency. Furthermore, the suction duct 220 and the discharging duct 240 may be insulated, minimizing heat loss when the cooled air flows through a closed flow path.

According to the battery system as configured above, the battery housing and the blower may be spaced substantially apart to decrease noise disturbances and to decrease space for cooling and heating the components. Further, the cooling efficiency decrease may be prevented by achieving minimum cooling air flow. In other words, the housing in which the battery pack is disposed and the cooling device may be spaced at a predetermined distance to ensure efficient performance, decrease noise disturbances and further improve air cooling efficiency by designing the battery system as a closed flow path system.

While the present invention has been illustrated and described with reference to specific embodiments, it should be apparent to those skilled in the art to which the present invention pertains that the present invention may be variously improved and changed without departing from the scope of the present invention.

What is claimed is:

1. A battery system comprising:
an airtight housing through which air is blocked;
a battery pack unit disposed in the airtight housing;
a suction opening and a discharging opening disposed in the airtight housing;
an airtight cooling device spaced apart from the airtight housing and from a vehicle seat, wherein the airtight cooling device is connected to the suction opening and the discharging opening through a suction duct and a discharging duct;
a blowing fan disposed in the airtight cooling device, wherein the blowing fan is configured to circulate the air in the airtight housing; and
a thermoelectric element disposed on an air circulating flow path of the airtight cooling device, wherein the thermoelectric element is configured to cool and to heat the circulated air.

2. The battery system of claim 1, wherein the airtight housing is disposed on a side of a vehicle floor and the cooling device is disposed on a side of a vehicle trunk.

3. The battery system of claim 1, wherein the suction opening is disposed on a lower portion of the airtight housing and is configured to suction the air therethrough.

4. The battery system of claim 1, wherein the discharging opening is disposed on an upper portion of the airtight housing and is configured to discharge the air therethrough.

5. The battery system of claim 1, wherein the blowing fan is a radial type fan configured to suction the air toward a middle of the blowing fan and discharge the air toward a side of the airtight housing.

6. The battery system of claim 1, further comprising a cooling device unit including the suction duct, the discharging duct and the blowing fan.

7. The battery system of claim 6, wherein the thermoelectric element is disposed on an air flow path of each cooling device.

8. The battery system of claim 1, wherein the airtight housing, the suction duct, the discharging duct and the cooling device are configured to block external air and form a closed flow path.

9. The battery system of claim 1, wherein the thermoelectric element is disposed in the suction duct.

10. The battery system of claim 1, wherein the thermoelectric element is disposed in the discharging duct.

11. The battery system of claim 1, further comprising a cooling device unit including the suction duct and the blowing fan, a plurality of divided ducts, wherein the plurality of divided ducts are divided from the discharging duct and are connected to the respective blowing fans.

12. The battery system of claim 11, wherein the thermoelectric element is disposed on an air flow path of each cooling device.

13. The battery system of claim 11, wherein the thermoelectric element is disposed in the respective suction ducts.

14. The battery system of claim 13, wherein the battery pack unit in the airtight housing is disposed in a plurality of columns.

15. The battery system of claim 14, further comprising a connection duct configured to connect the plurality of columns of the battery pack unit, wherein the discharging opening is configured to connect to the discharging duct in the airtight housing to a corresponding column of the battery pack unit.

16. The battery system of claim 14, wherein one end of the connection duct is connected to the discharging opening and the other end of the connection duct is divided to connect the plurality of columns of the battery pack unit, wherein the air flows through the respective battery packs.
